(19) United States
(12) Patent Application Publication
(10) Pub. No.: US 2026/0225602 A1
(43) Pub. Date: Aug. 6, 2026

(54) DRIVING ASSISTANCE DEVICE

(71) Applicant: HONDA MOTOR CO., LTD., Tokyo (JP)

(72) Inventors: Keita AKIHO, Tokyo (JP); Shota HOSHAKU, Tokyo (JP); Koichi FUJIMAKI, Tokyo (JP)

(21) Appl. No.: 19/423,193

(22) Filed: Dec. 17, 2025

(30) Foreign Application Priority Data
Jan. 31, 2025 (JP) 2025-015301

(51) Int. Cl. B60W 50/14; B60W 50/02

(52) U.S. Cl. CPC B60W 50/14; B60W 50/0205; B60W 2050/021; B60W 2050/0215; B60W 2050/143; B60W 2050/146; B60W 2540/215; B60W 2555/20

(57) ABSTRACT

When the controller does not receive the signal from at least one of the external environment sensors and determines that the outside temperature measured by the temperature measuring device is equal to or higher than a prescribed value, the controller determines that the at least one of the external environment sensors has failed and cause the notification device to notify information regarding a failure of the driving assistance device. When the controller does not receive the signal from at least one of the external environment sensors and determines that the outside temperature measured by the temperature measuring device is lower than the prescribed value, the controller determines that the at least one of the external environment sensors is inoperative due to a low temperature and cause the notification device to notify information indicating that the driving assistance device is in a degraded performance state.

### TECHNICAL FIELD

The present invention relates to a driving assistance device mounted on a vehicle.

### BACKGROUND ART

In recent years, efforts have been actively made to provide access to sustainable transport systems that take into account people in vulnerable situations among traffic participants. To achieve this, research and development for further improving safety and convenience of traffic through development of driving assistance technologies is being conducted.

In the driving assistance technology, it is necessary to detect objects around a vehicle by an external environment sensor provided on the vehicle. The external environment sensor includes millimeter-wave radar, sonars, lidar, and cameras. Various technologies have been proposed to enable the external environmental sensors and other devices to be used in a low-temperature environment. For example, JP2023-106834A discloses a controller that uses a heater to melt snow on members around the radar. Further, JP2018-019464A discloses a method for controlling temperature rise of a power supply unit in an electric vehicle, such as warming up a fuel cell or heating a secondary battery.

However, a user of the vehicle may use the vehicle before a vehicle equipment is sufficiently warmed up. For example, at low temperatures of -30°C to -40°C or below, a microcontroller installed in the external environment sensor may not operate, and the external environment sensor may not be able to transmit a signal to a controller of the vehicle. Meanwhile, a failure of the external environment sensor may prevent the external environment sensor from transmitting the signal to the controller of the vehicle. Conventionally, when the controller cannot receive the signal from the external environment sensor, the controller determines that the external environment sensor that is not transmitting the signal has failed, and outputs a message prompting the user to request repair. Accordingly, even when the external environment sensor is unable to transmit the signal due to low temperature rather than the failure, the user may bring the vehicle provided with the external environment sensor to a vehicle dealer for repair, and the vehicle dealer requested to perform the repair may inspect the external environment sensor to confirm that the sensor is not failed, which could result in wasting time and inspection cost for the user.

### SUMMARY OF THE INVENTION

In view of the above background, to contribute to the development of sustainable transportation systems, an object of the present invention is to provide a driving assistance device that does not compromise safety and prevents a user of a vehicle from misrecognizing performance degradation of an external environment sensor in a low-temperature environment as having failed.

To achieve such an object, one aspect of the present invention provides a driving assistance device of a vehicle including a propulsion device, a brake device, and a steering device, the driving assistance device including: a temperature measuring device configured to measure an outside temperature; a plurality of external environment sensors configured to detect an object around the vehicle; a controller configured to receive a signal from the temperature measuring device and a signal from each of the external environment sensors, and control at least one of the propulsion device, the brake device, and the steering device to assist a user in driving the vehicle; and a notification device configured to notify the user of information based on control by the controller. When the controller does not receive the signal from at least one of the external environment sensors and determines that the outside temperature measured by the temperature measuring device is equal to or higher than a prescribed value, the controller is configured to determine that the at least one of the external environment sensors has failed and cause the notification device to notify information regarding a failure of the driving assistance device, and when the controller does not receive the signal from at least one of the external environment sensors and determines that the outside temperature measured by the temperature measuring device is lower than the prescribed value, the controller is configured to determine that the at least one of the external environment sensors is inoperative due to a low temperature and cause the notification device to notify information indicating that the driving assistance device is in a degraded performance state.

Thus, according to the above aspects, it is possible to provide the driving assistance device that does not compromise safety and prevents the user of the vehicle from misrecognizing the performance degradation of the external environment sensor in the low-temperature environment as having failed.

### BRIEF DESCRIPTION OF THE DRAWINGS

FIG. 1 is a side view of a vehicle provided with a driving assistance device according to a present embodiment.

FIG. 2 is a functional block diagram of the driving assistance device according to the present embodiment; and

FIG. 3 is a flowchart showing a processing flow of the driving assistance device according to the present embodiment (to secure a sufficient drawing space, a hexagon (a symbol indicating “preparation”) is used instead of a diamond, which is a symbol indicating a decision or branch).

### DETAILED DESCRIPTION OF THE INVENTION

In the following, an embodiment of the present invention will be described with reference to the drawings. In the following description, directions such as front, rear, left, right, up, and down are directions defined relative to a vehicle 1.

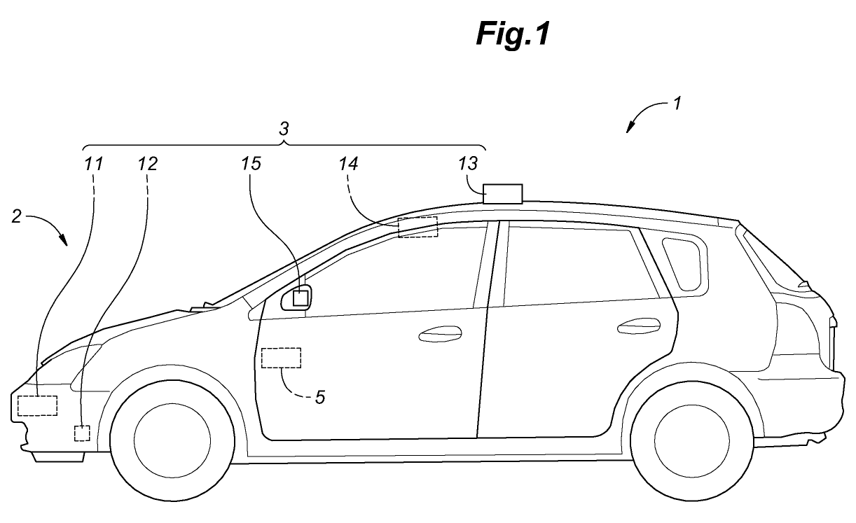

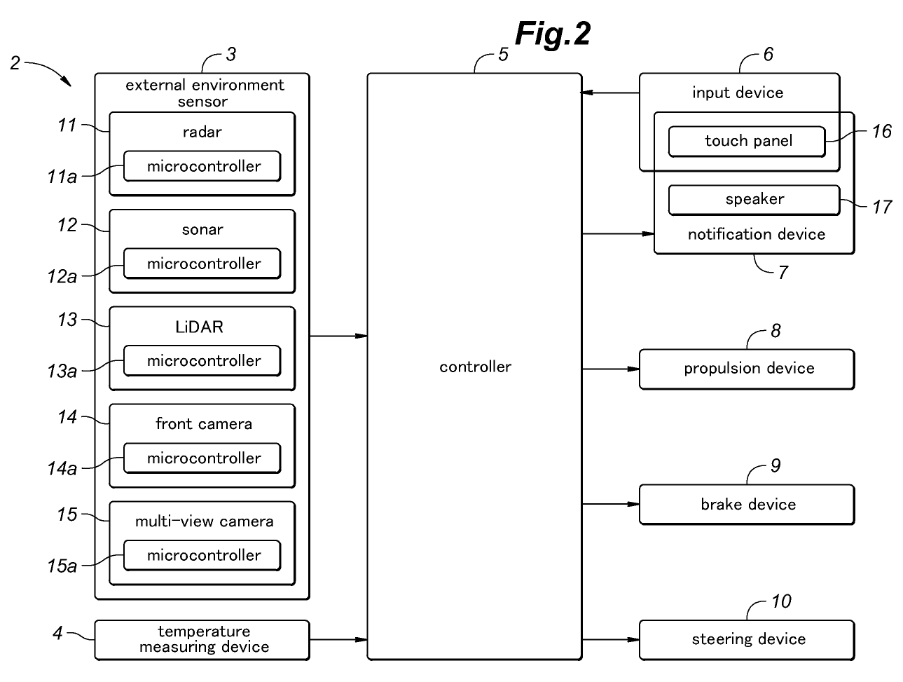

As shown in FIGS. 1 and 2, a driving assistance device 2 mounted on the vehicle 1 includes an external environment sensor 3, a temperature measuring device 4, a controller 5 that receives signals from the external environment sensor 3 and the temperature measuring device 4, an input device 6 that inputs information to the controller 5, and a notification device 7, a propulsion device 8, a brake device 9, and a steering device 10 that are controlled by the controller 5. The components of the driving assistance device 2 are connected to each other so that signals can be transmitted via communication means such as a controller area network (CAN).

The external environment sensor 3 captures electromagnetic waves, sound waves, and the like from the surroundings of the vehicle 1, detects objects outside the vehicle, and acquires information about the surroundings of the vehicle 1. The external environment sensor 3 includes a radar 11, a sonar 12, a lidar 13, a front camera 14, and a multi-view camera 15. The components of the external environment sensor 3 include microcontrollers 11a, 12a, 13a, 14a, and 15a, respectively, and when the microcontrollers 11a, 12a, 13a, 14a, and 15a are started up and programs stored therein are executed, the microcontrollers acquire circumferential information and transmit the acquired information to the controller 5. The microcontrollers 11a, 12a, 13a, 14a, and 15a do not operate normally in a low temperature environment, for example, an environment below -30°C to -40°C, and are unable to transmit signals to the controller 5.

The radar 11 detects the position (distance and direction) of the object by emitting radio waves, such as millimeter waves, to the surroundings of the vehicle 1 and capturing the reflected waves. The radar 11 is provided in the center of the front end of the vehicle 1 in the lateral direction, and includes a front radar that emits radio waves toward the front direction of the vehicle 1. Although not shown in the drawings, it is preferable that the radar 11 further includes a rear radar that is provided in the center of the rear end of the vehicle 1 in the lateral direction and emits radio waves toward the rear direction of the vehicle 1, and a pair of left and right side radars that are provided on the sides or corners of the vehicle 1 and emit radio waves toward the lateral or obliquely lateral directions of the vehicle 1.

The sonars 12 are so-called ultrasonic sensors, and detect the position (distance and direction) of the object by emitting ultrasonic waves to the surroundings of the vehicle 1 and capturing the reflected waves. The sonars 12 include front sonars that are provided in pairs on the lateral sides of the front end of the vehicle 1 in the lateral direction and detect the position of the object in front of the vehicle 1. Although not shown, it is preferable that the sonars 12 further include rear sonars that are provided in pairs on the lateral side of the rear end of the vehicle 1 in the lateral direction and detect the position of the object behind the vehicle 1.

The lidar 13 detects the position (distance and direction) of the object by emitting light, such as infrared light, to the surroundings of the vehicle 1 and capturing the reflected light. The lidar 13 is provided on the upper portion of the vehicle 1.

The front camera 14 and the multi-view camera 15 capture images of the surroundings of the vehicle 1, including surrounding vehicles, pedestrians, guardrails, curbs, walls, medians, the shape of the road, delimiting lines and road markings painted on the road, and the like. The front camera 14 and the multi-view camera 15 may be, for example, digital cameras that use solid-state image sensors such as CCDs or CMOSs. The front camera 14 is provided on the in-vehicle side of the window panel of the vehicle 1 and captures images of the area in front of the vehicle 1. The multi-view camera 15 is provided, for example, on a door mirror. The images captured by the multi-view camera 15 are synthesized by the controller 5, and the synthesized image in any direction is displayed on the notification device 7.

It is preferable that a part or all of the external environment sensors 3 have a self-diagnosis function that determines whether the object to be detected can be detected normally, and, when an abnormality is detected, transmit the information on the abnormality to the controller 5. For example, the abnormality is determined when snow or ice adheres to the radar 11, when foreign object adheres to the sonar 12, or when the windshield becomes fogged and the image captured by the front camera 14 becomes unclear. The self-diagnosis is performed by the microcontrollers 11a, 12a, 13a, 14a, and 15a of each external environment sensor 3 determining whether an abnormal state exists. For example, the microcontrollers 11a, 12a, 13a, 14a, and 15a may determine that the abnormal state exists when a pressure sensor (not shown) provided in each external environment sensor 3 detects pressure different from normal pressure (pressure due to ice, snow, or foreign object), or may determine that the abnormal state exists when a detection result different from that of other external environment sensors 3 is acquired in an area where the detection range overlaps with that of other external environment sensors 3. The microcontroller 14a of the front camera 14 may also determine that the abnormal state exists when the captured image includes a pre-stored image pattern for a fogged windshield. When the controller 5 receives the information on abnormality from the external environment sensor 3, the controller 5 causes the notification device 7 to notify the user of the vehicle 1 that the driving assistance function is in a degraded performance state. The external environment sensor 3 identifies the cause of the problem that has occurred in the external environment sensor 3 based on the self-diagnosis function, and transmits the information to the controller 5. The controller 5, when the cause is resolvable by the user of the vehicle 1, causes the notification device 7 to notify the user of the solution method, and when the cause is not resolvable by the user, causes the notification device 7 to notify a message prompting the user to bring the vehicle 1 to a vehicle dealer.

The temperature measuring device 4 is arranged near the outer surface of the vehicle 1, measures the outside temperature, and transmits the measured outside temperature to the controller 5. The temperature measuring device 4 may be a device that is arranged outside the vehicle 1 and is capable of communicating with the controller 5.

The controller 5 is an electronic controller (ECU) consisting of a CPU, ROM, RAM, and the like. The controller 5 executes various vehicle controls by executing arithmetic processing according to a program using the CPU. The controller 5 may be composed of a single piece of hardware, or may be composed of a unit including a plural pieces of hardware. Further, at least a portion of the functional units of the controller 5 may be realized by hardware such as an LSI, an ASIC, or an FPGA, or may be realized by a combination of software and hardware.

The input device 6 accepts input from the user and transmits the input information to the controller 5. The notification device 7 notifies the user of various information by display or sound. The vehicle 1 is provided with a touch panel 16, which functions as the input device 6 and the notification device 7. The touch panel 16 displays images captured by the front camera 14 and the multi-view camera 15, as well as text information and images generated by the controller 5. The notification device 7 further includes a speaker 17 that outputs voice, warning sounds, and the like. A mobile terminal, such as a smartphone (not shown), capable of communicating with the controller 5 may be used as the input device 6 and the notification device 7.

The propulsion device 8 is a device that provides driving force to the vehicle 1, and includes, for example, a power source and a transmission. The power source includes at least one of an internal combustion engine, such as a gasoline engine or a diesel engine, and an electric motor. The brake device 9 is a device that applies a braking force to the vehicle 1, and includes, for example, a brake caliper that presses a pad against a brake rotor, and an electric cylinder that supplies hydraulic pressure to the brake caliper. The brake device 9 may include a parking brake device that restricts the rotation of the wheels by a wire cable. The steering device 10 is a device for changing the steering angle of the wheels, and includes, for example, a rack-and-pinion mechanism for steering the wheels, and an electric motor for driving the rack-and-pinion mechanism.

The controller 5 realizes a plurality of driving assistance functions by controlling the propulsion device 8, the brake device 9, and the steering device 10 based on the detection result of the external environment sensor 3. For example, the controller 5 controls the propulsion device 8 and the brake device 9 to maintain an appropriate distance between the vehicles based on the distance to the preceding vehicle detected by the external environment sensor 3 (active cruise control (ACC)). For example, when the external environment sensor 3 detects an obstacle with which the vehicle 1 may collide, the controller 5 activates the brake device 9 (collision mitigation brake system (CMBS)). For example, the controller 5 controls the steering device 10 based on the delimiting lines captured by the front camera 14 and the multi-view camera 15 to maintain the vehicle in the lane (lane keeping assist system (LKAS)).

The control flow of the driving assistance device 2 according to the present embodiment will be described with reference to FIGS. 1 to 3.

The controller 5 determines whether the signals are received from each of the external environment sensors 3 (ST1). When the signals are received from all the external environment sensors 3 (Yes in ST1), the controller 5 executes all the driving assistance functions normally (ST2).

When the controller 5 does not receive the signal from at least one of the external environment sensors 3 (No in ST1), the controller 5 determines whether the outside temperature measured by the temperature measuring device 4 is lower than the prescribed value (ST3). The prescribed value may be a value common to all the external environment sensors 3, but is preferably set for each of the types of the external environment sensors 3 and is set to a temperature within a range from the lower operating temperature of each of the external environment sensors 3 to a temperature approximately 10°C higher than the lower operating temperature. At the time of filing of the present application, the lower operating temperatures of the commercially available radar 11, the sonar 12, the lidar 13, and the front camera 14 for the vehicle are approximately -40°C, and the lower operating temperature of the commercially available multi-view camera 15 for the vehicle is approximately -30°C. Accordingly, for example, the prescribed values of the radar 11, the sonar 12, the lidar 13, and the front camera 14 may be set to -30°C, and the prescribed value of the multi-view camera 15 may be set to -20°C, or the prescribed values of the radar 11, the sonar 12, the lidar 13, the front camera 14, and the multi-view camera 15 may all be set to -30°C.

When the controller 5 determines that the outside temperature is lower than the prescribed value (Yes in ST3), the controller 5 restricts the execution of the driving assistance function that requires information from the external environment sensor 3 that is not transmitting a signal, and causes the notification device 7 to notify the user of information indicating that the driving assistance function is in the degraded performance state. When the controller 5 does not receive information from all the external environment sensors 3 required for executing a certain driving assistance function, the controller 5 does not execute the driving assistance function. When the controller 5 does not receive the signal from a part of the external environment sensors 3 required for executing a certain driving assistance function (for example, in the driving assistance function that requires information from the plurality of sonars 12, when the signals are not received from a part of the sonars 12, or in the driving assistance function that requires information from the radar 11 and the sonars 12, when the signal is not received from the radar), the controller 5 either does not execute or executes in the degraded performance state the driving assistance function. It is preferable that the information notified by the notification device 7 indicating that the driving assistance function is in the degraded performance state be concise. For example, when a part of the driving assistance functions is not executed and/or when the part of the driving assistance functions is executed in the degraded performance state, the notification device 7 simply notifies the driver of the information indicating that the performance of the driving assistance functions is degraded. At this time, it is preferable that the controller 5 displays the detailed information button on the touch panel 16, and when the user presses the button, the controller 5 causes the notification device 7 to notify the detailed information. For example, the controller 5 displays the detailed information, such as which driving assistance functions are suspended or in the degraded performance state, which driving assistance functions are being executed normally, which signals from the external environment sensors 3 are not received, and/or that the driving assistance function may recover as the temperature rises, on the touch panel 16 in text and/or images.

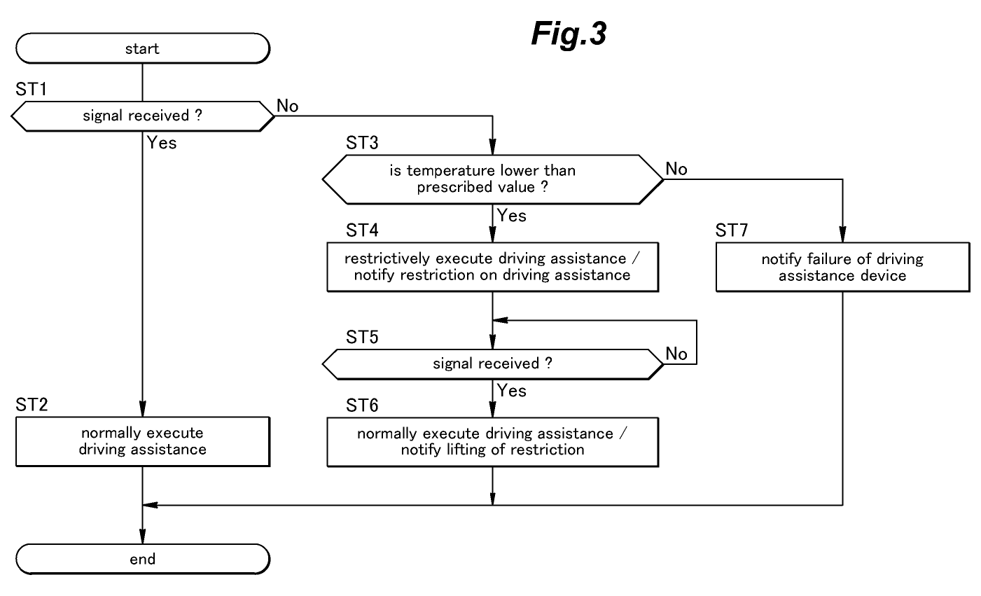

The controller 5 continues either not to execute or to execute in a restricted manner the driving assistance function while the state in which the signal from the external environment sensor 3 is not received continues (No in ST5). When the controller 5 receives a signal from the external environment sensor 3 that has not been received (Yes in ST5), the controller 5 executes the driving assistance function involving that external environment sensor 3 normally. When all the driving assistance functions are being executed normally, the controller 5 causes the notification device 7 to notify the user that the restriction on the driving assistance functions has been lifted (ST6). Further, when the temperature of each microcontroller 11a, 12a, 13a, 14a, and 15a of the external environment sensors 3 is close to the lower limit of the operable temperature, the operation and stoppage of the microcontrollers 11a, 12a, 13a, 14a, and 15a may be repeatedly switched, and the controller 5 may frequently alternate between a signal receivable state and signal unreceivable state. In such a case, so as to prevent the notification of the restriction on the driving assistance (when the process in the flowchart of FIG. 3 is completed and then restarted, and reaches ST4) and the notification of the lifting of the restriction (ST6) from being repeated, it is preferable that the notification of the lifting of the restriction be made when signals from all the external environment sensors 3 have been received continuously for the prescribed time of longer.

When the controller 5 determines that the outside temperature is equal to or higher than the prescribed value (No in ST3), the controller 5 determines that the external environment sensor 3 that is not transmitting a signal has failed, and causes the notification device 7 to notify the user that the driving assistance device 2 has failed (ST7). Further, even when the controller 5 determines that the part of the external environment sensors 3 has failed, the controller 5 may normally execute or execute in a restricted manner the driving assistance functions involving the other external environment sensors 3. The content of the notification from the notification device 7 preferably includes a message prompting the user to bring the vehicle 1 to the vehicle dealer. Further, the controller 5 may cause the notification device 7 to notify the failure and display the detailed information button on the touch panel 16. When the user presses the button, the controller 5 may cause the notification device 7 to provide the detailed information, for example, which external environment sensor 3 has failed and which driving assistance function is suspended, executed in a restricted manner, or normally executed.

It is conceivable that, when the controller 5 determines that the external environment sensor 3 is inoperative due to the low temperature and the driving assistance function is executed in a restricted manner (after ST4), the controller 5 may not receive a signal from the external environment sensor 3 even though the outside temperature has risen and becomes equal to or higher than the prescribed value. In such a case, the controller 5 may determine that the external environment sensor 3 has failed and cause the notification device 7 to notify the information regarding the failure of the driving assistance device 2.

The effects of the driving assistance device 2 will be described. According to the driving assistance device 2, even when the controller 5 does not receive the signal from the external environment sensor 3, when the outside temperature is lower than the prescribed temperature, the controller 5 determines that the external environment sensor 3 is inoperative due to the low temperature and causes the notification device 7 to notify that the driving assistance function is degraded. This prevents the user of the vehicle 1 from misrecognizing the external environment sensor 3, which is inoperative due to the low temperature, as having failed. Accordingly, the user is prevented from unnecessarily requesting repair of the vehicle 1 to the vehicle dealer, thereby improving user convenience. Further, since the performance degradation of the driving assistance function is notified, the user of the vehicle 1 can recognize that the driving assistance provided by the driving assistance device 2 is degraded, and is prompted to pay more attention to driving the vehicle 1, so that safety is maintained. Even when the controller 5 determines that the external environment sensor 3 is inoperative due to the low temperature, when in fact the external environment sensor 3 has failed, the user of the vehicle 1 recognizes that the driving assistance function is degraded in performance. Since the performance degradation of the driving assistance function is equivalent to that caused by the low temperature, safety is maintained. Further, even when the controller 5 determines that the external environment sensor 3 is inoperative, when the outside temperature subsequently rises and becomes equal to or higher than the prescribed value, the controller 5 determines that the external environment sensor 3 has failed, thereby preventing a decrease in user convenience.

The vehicle 1 includes a plurality of types of external environment sensors 3, so that many types of driving assistance functions can be executed. Further, a threshold value (the prescribed value) is set for each of the types of external environment sensors 3 at which the external environment sensor 3 is considered to be inoperative due to the low temperature, thereby improving the accuracy of determination by the controller 5 as to whether the external environment sensor 3 has failed or is inoperative due to the low temperature.

When the external environment sensor 3 detects the abnormality based on the self-diagnosis function, the external environment sensor 3 transmits the information to the controller 5, and the controller 5 causes the notification device 7 to notify the user of the performance degradation of the driving assistance function, thereby alerting the user and preventing a reduction of safety.

Since the initial information notified to the user when the performance of the driving assistance function degraded is simple, the user is prevented from unnecessarily paying more attention to understand the content of the notification while driving, thereby preventing the reduction of safety. Further, the detailed information is notified only when the user desires the information, so that the user who wants the detailed information receives the information, and the user who does not want the information is not bothered by excessive information.

The controller 5 causes the notification device 7 to notify that the restriction on the driving assistance function has been lifted after the prescribed time has elapsed since the controller 5 becomes able to receive the signal from the external environment sensor 3. This prevents repeated notifications of the restriction and lifting of the restriction on the driving assistance function when the signal transmission by the external environment sensor 3 is unstable. A state may temporarily occur in which, although the driving assistance function is executed normally, the user recognizes the driving assistance function as being restricted. However, the state acts to enhance safety, and safety is maintained.

The present embodiment is not limited to the above configuration and can be widely modified and implemented. For example, so as to simplify the information notified to the user, the information notified by the notification device 7 indicating that the driving assistance function is in the degraded performance state may be a message that the driving assistance function is temporarily suspended rather than a message that the driving assistance function is degraded, even when the part of the driving assistance functions are being executed.

The above embodiment may also be described as follows. One embodiment provides a driving assistance device 2 of a vehicle 1 including a propulsion device 8, a brake device 9, and a steering device 10, the driving assistance device 2 including: a temperature measuring device 4 configured to measure an outside temperature; a plurality of external environment sensors 3 configured to detect an object around the vehicle 1; a controller 5 configured to receive a signal from the temperature measuring device 4 and a signal from each of the external environment sensors 3, and control at least one of the propulsion device 8, the brake device 9, and the steering device 10 to assist a user in driving the vehicle 1; and a notification device 7 configured to notify the user of information based on control by the controller 5. When the controller 5 does not receive the signal from at least one of the external environment sensors 3 and determines that the outside temperature measured by the temperature measuring device 4 is equal to or higher than a prescribed value the controller 5 is configured to determine that the at least one of the external environment sensors 3 has failed and cause the notification device 7 to notify information regarding a failure of the driving assistance device 2, and when the controller 5 does not receive the signal from at least one of the external environment sensors 3 and determines that the outside temperature measured by the temperature measuring device 4 is lower than the prescribed value, the controller 5 is configured to determine that the at least one of the external environment sensors 3 is inoperative due to a low temperature and cause the notification device 7 to notify information indicating that the driving assistance device 2 is in a degraded performance state.

According to this aspect, the user of the vehicle 1 is prevented from misrecognizing the external environment sensor 3, which is inoperative due to the low temperature, as having failed. This prevents the user from unnecessarily requesting repair of the vehicle 1 to the vehicle dealer, thereby improving user convenience. Further, since the performance degradation of the driving assistance function is notified, the user of the vehicle 1 can recognize that the driving assistance provided by the driving assistance device 2 is degraded, and is prompted to pay more attention to driving the vehicle 1, so that safety is maintained.

In the above aspect, preferably, the plurality of external environment sensors 3 includes a plurality of types of sensors.

According to this aspect, many different types of the driving assistance functions can be executed.

In the above aspect, preferably, the prescribed value is set for each of the types of the external environment sensors 3.

According to this aspect, the accuracy of determination by the controller 5 as to whether the external environment sensor 3 has failed or is inoperative due to the low temperature.

In the above aspect, preferably, the controller 5 is capable of executing a plurality of types of driving assistance functions, and when the controller 5 does not receive the signal from only a part of the external environment sensors 3, the controller 5 either does not execute or executes in a degraded performance state the driving assistance function involving the part of the external environment sensors 3, and normally executes the driving assistance function not involving the part of the external environment sensors 3.

According to this aspect, since the executable driving assistance functions are executed, the reduction of safety is suppressed.

In the above aspect, preferably, each of the external environment sensors 3 has a self-diagnosis function that determines whether the object can be detected normally, and when the controller 5 receives a signal from one of the external environment sensors 3 indicating that the object cannot be detected normally, the controller 5 causes the notification device 7 to notify the information indicating that the driving assistance device 2 is in the degraded performance state.

According to this aspect, when the external environment sensor 3 detects the abnormality based on the self-diagnosis function, the external environment sensor 3 transmits the information to the controller 5, and the controller 5 causes the notification device 7 to notify the user of the performance degradation of the driving assistance function, thereby alerting the user and preventing the reduction of safety.

In the above aspect, preferably, the driving assistance device further includes an input device 6 configured to accept input from the user, and the controller 5 determines that the external environment sensor 3 is inoperative due to the low temperature and causes the notification device 7 to notify the information indicating that the driving assistance device 2 is in the degraded performance state, and then causes the notification device 7 to notify detailed information about the degraded performance state based on the input from the user via the input device 6.

According to this aspect, the detailed information is notified only when the user requests, so that the user who wants the detailed information receives the information, and the user who does not want the information is not bothered by excessive information.

In the above aspect, preferably, when the controller 5 determines that one of the external environment sensors 3 is inoperative due to the low temperature and causes the notification device 7 to notify the information indicating that the driving assistance device 2 is in the degraded performance state, and then receives a signal from the one of the external environment sensors 3 that is determined to be inoperative, the controller 5 executes the driving assistance function that becomes available upon reception of the signal from the one of the external environment sensors 3, and when the reception of the signal from the one of the external environment sensors 3 continues for a prescribed time or longer, the controller 5 causes the notification device 7 to notify the information indicating that the degraded performance state of the driving assistance device 2 has ceased.

According to this aspect, the controller 5 causes the notification device 7 to notify that the restriction on the driving assistance function has been lifted after the prescribed time has elapsed since the controller 5 becomes able to receive the signal from the external environment sensor 3. This prevents repeated notifications of the restriction and lifting of the restriction on the driving assistance function when the signal transmission by the external environment sensor 3 is unstable.

1. A driving assistance device of a vehicle comprising a propulsion device, a brake device, and a steering device, the driving assistance device comprising:
a temperature measuring device configured to measure an outside temperature;
a plurality of external environment sensors configured to detect an object around the vehicle;
a controller configured to receive a signal from the temperature measuring device and a signal from each of the external environment sensors, and control at least one of the propulsion device, the brake device, and the steering device to assist a user in driving the vehicle; and
a notification device configured to notify the user of information based on control by the controller, wherein
when the controller does not receive the signal from at least one of the external environment sensors and determines that the outside temperature measured by the temperature measuring device is equal to or higher than a prescribed value, the controller is configured to determine that the at least one of the external environment sensors has failed and cause the notification device to notify information regarding a failure of the driving assistance device, and
when the controller does not receive the signal from at least one of the external environment sensors and determines that the outside temperature measured by the temperature measuring device is lower than the prescribed value, the controller is configured to determine that the at least one of the external environment sensors is inoperative due to a low temperature and cause the notification device to notify information indicating that the driving assistance device is in a degraded performance state.

2. The driving assistance device according to claim 1, wherein the plurality of external environment sensors includes a plurality of types of sensors.

3. The driving assistance device according to claim 2, wherein the prescribed value is set for each of the types of the external environment sensors.

4. The driving assistance device according to claim 2, wherein the controller is capable of executing a plurality of types of driving assistance functions, and
when the controller does not receive the signal from only a part of the external environment sensors, the controller either does not execute or executes in a degraded performance state the driving assistance function involving the part of the external environment sensors, and normally executes the driving assistance function not involving the part of the external environment sensors.

5. The driving assistance device according to claim 1, wherein each of the external environment sensors has a self-diagnosis function that determines whether the object can be detected normally, and
when the controller receives a signal from one of the external environment sensors indicating that the object cannot be detected normally, the controller causes the notification device to notify the information indicating that the driving assistance device is in the degraded performance state.

6. The driving assistance device according to claim 1, further comprising an input device configured to accept input from the user, wherein
the controller determines that the external environment sensor is inoperative due to the low temperature and causes the notification device to notify the information indicating that the driving assistance device is in the degraded performance state, and then causes the notification device to notify detailed information about the degraded performance state based on the input from the user via the input device.

7. The driving assistance device according to claim 1, wherein
when the controller determines that one of the external environment sensors is inoperative due to the low temperature and causes the notification device to notify the information indicating that the driving assistance device is in the degraded performance state, and then receives a signal from the one of the external environment sensors that is determined to be inoperative, the controller executes the driving assistance function that becomes available upon reception of the signal from the one of the external environment sensors, and
when the reception of the signal from the one of the external environment sensors continues for a prescribed time or longer, the controller causes the notification device to notify the information indicating that the degraded performance state of the driving assistance device has ceased.
